(19) United States
(12) Patent Application Publication
(10) Pub. No.: US 2020/0117031 A1
(43) Pub. Date: Apr. 16, 2020

(54) LIQUID CRYSTAL DEVICE AND ELECTRONIC APPARATUS

(71) Applicant: SEIKO EPSON CORPORATION, Tokyo (JP)

(72) Inventors: Norihito HARADA, Azumino-shi (JP); Hirokazu AYUKAWA, Suwa-shi (JP)

(73) Assignee: SEIKO EPSON CORPORATION, Tokyo (JP)

(21) Appl. No.: 16/596,828

(22) Filed: Oct. 9, 2019

(30) Foreign Application Priority Data
Oct. 10, 2018 (JP) 2018-191520

(51) Int. Cl. G02F 1/1337; G02F 1/1343

(52) U.S. Cl. CPC G02F 1/1337; G02F 1/13439; G03B 21/006; G02F 2201/121; G02F 2201/123; G02F 2001/133749

(57) ABSTRACT

In a liquid crystal device, a sheet resistance of an ITO film constituting a common electrode is set to be not less than 19Ω/□ and not more than 44Ω/□ so that the surface roughness of the ITO film is managed. Accordingly, a pre-tilt angle θp of a liquid crystal material can be set to 4.3±0.6°, which can suppress the video domain and improve the contrast. Additionally, a specific resistance of the ITO film may be set to be not less than 2740 nm·Ω/□ and not more than 6740 nm·Ω/□. In addition, in an X-ray diffraction result of the ITO film, an intensity Ia of a crystal plane orientation and an intensity Ib of a crystal plane orientation is configured to satisfy a following relationship:

0.85≤(Ia/(Ia+Ib))≤0.92

The present application is based on, and claims priority from JP Application Serial Number 2018-191520, filed Oct. 10, 2018, the disclosure of which is hereby incorporated by reference herein in its entirety.

### BACKGROUND

### 1. Technical Field

The present disclosure relates to a liquid crystal device and an electronic apparatus.

### 2. Related Art

In the liquid crystal display device, a liquid crystal layer is provided between a first substrate provided with a pixel electrode and a first oriented film at one side and a second substrate provided with a common electrode and a second oriented film. In recent years, in order to achieve high-speed driving and high contrast, a liquid crystal device of VA (Vertical Alignment) mode in which liquid crystal material is vertically aligned using a liquid crystal material having negative dielectric anisotropy in a liquid crystal layer has been proposed. Also, a technique has been proposed in which a first alignment film and a second alignment film are used to apply pre-tilt to a liquid crystal material to tilt the long axis direction of the liquid crystal material obliquely with respect to the normal direction of the first substrate and the second substrate, thereby controlling the direction in which the liquid crystal material incline when a voltage is applied.

In such a liquid crystal device, since the quality of the first oriented film and the second oriented film is affected by the surface roughness of the pixel electrode and the common electrode serving as the base, there is a problem that the pre-tilt angle applied to the liquid crystal material tends to vary. Therefore, after forming an indium tin oxide film (ITO film) which constitutes the common electrode or the like, the surface roughness of the ITO film may be managed, but the surface roughness of the ITO film is on the nano order. For this reason, the surface roughness of the ITO film needs to be measured using an atomic force microscope, but in the atomic force microscope, there is a problem that the measurement of surface roughness tends to vary due to the deterioration of a cantilever or the individual difference in the cantilevers.

On the other hand, as a technology for managing film quality, a technology is conceivable which manages sheet resistance, transmittance, and light absorptance of ITO films by the intensity ratio of crystal plane orientation (222), (400), and (440) obtained by X-ray diffraction of the ITO film (see JP-T-2016-506015).

However, the technology disclosed in JP-T-2016-506015is a technology for managing the sheet resistance, transmittance, and light absorptance of ITO films, and does not manage the surface roughness of the ITO film and the pre-tilt angle applied to the liquid crystal material. Therefore, there is a problem in the related technology that the pre-tilt angle applied to the liquid crystal material cannot be controlled within a proper range.

### SUMMARY

In order to solve an above-described problems, a liquid crystal device according to the present disclosure includes a pixel electrode, a common electrode, a first oriented film covering the pixel electrode, a second oriented film covering the common electrode, and a liquid crystal layer that is disposed between the first oriented film and the second oriented film and that includes a liquid crystal material. At least the common electrode of the pixel electrode and the common electrode includes an ITO film with a sheet resistance not less than 19Ω/□ and not more than 44Ω/□, and a pre-tilt angle that is a tilt angle of the liquid crystal material with respect to a thickness direction of the liquid crystal layer is not less than 3.7° and not more than 4.9°. Note that Ω/□ is ohms per square.

The liquid crystal device according to the present disclosure is used in various electronic apparatuses such as a projection-type display device.

### BRIEF DESCRIPTION OF THE DRAWINGS

FIG. 1 is a plan view illustrating a liquid crystal device to which an aspect of the present disclosure is applied.

FIG. 2 is an H-H′ cross-sectional view of the liquid crystal device illustrated in FIG. 1.

FIG. 3 is an explanatory view illustrating liquid crystal material or the like used in a liquid crystal layer illustrated in FIG. 2.

FIG. 4 is an explanatory view of a method, or the like, for forming a first oriented film and a second oriented film illustrated in FIG. 3.

FIG. 5 is an explanatory diagram illustrating a proper range of a pre-tilt angle illustrated in FIG. 3.

FIG. 6 is a graph illustrating a relationship between a sheet resistance and the pre-tilt angle of an ITO film illustrated in FIG. 3.

FIG. 7 is a graph illustrating a relationship between a specific resistance of the ITO film and the pre-tilt angle illustrated in FIG. 3.

FIG. 8 is an explanatory diagram illustrating an X-ray diffraction result of the ITO film illustrated in FIG. 3.

FIG. 9 is an explanatory diagram illustrating a relationship between an intensity of each crystal plane orientation and the pre-tilt angle illustrated in FIG. 8.

FIG. 10 is an explanatory diagram illustrating a relationship between a ratio of the intensity illustrated in FIG. 9 and the pre-tilt angle.

FIG. 11 is a graph illustrating a result of approximating Ia/(Ia+Ib) illustrated in FIG. 10 to a cubic function.

FIG. 12 is an explanatory view of a projection-type display device using a transmissive type liquid crystal device.

### DESCRIPTION OF EXEMPLARY EMBODIMENTS

Exemplary embodiments of the present disclosure will be described below with reference to the drawings. In the drawings referred to in the following description, the scale of each layer and each member is different in order to make each layer and each member have a size that can be recognized in the drawing.

### Configuration of Liquid Crystal Device

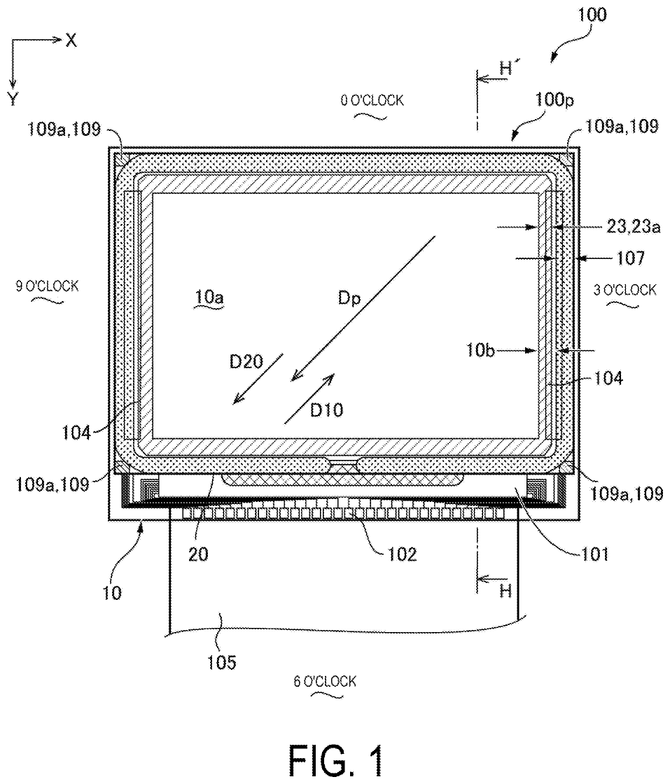

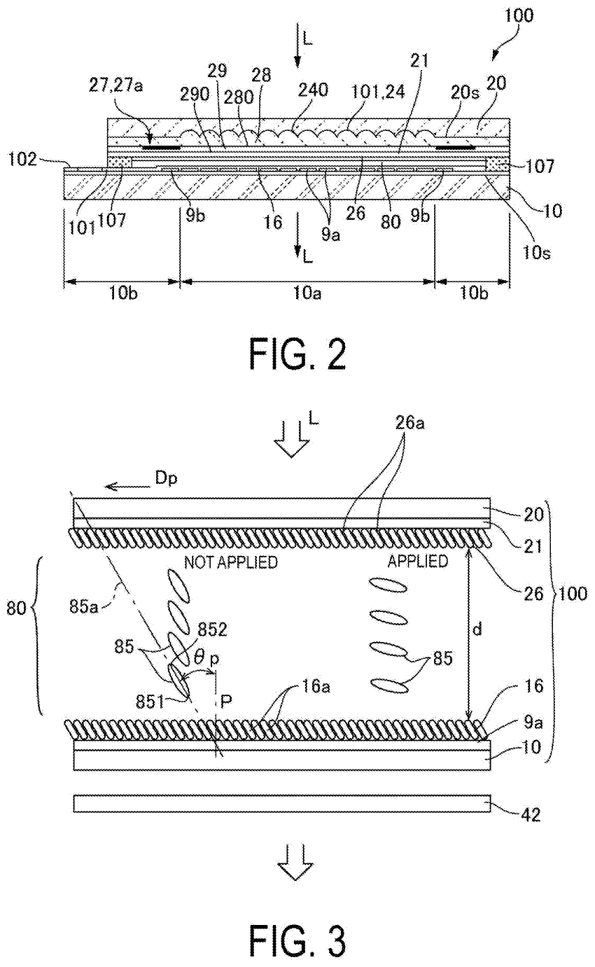

FIG. 1 is a plan view illustrating one aspect of a liquid crystal device 100 to which the present disclosure is applied, and illustrates a situation in which the liquid crystal device 100 is viewed from a second substrate 20 side. FIG. 2 is an H-H′ cross-sectional view of the liquid crystal device 100 illustrated in FIG. 1.

As illustrated in FIGS. 1 and 2, the liquid crystal device 100 includes a liquid crystal panel 100p including a light-transmitting first substrate 10 and a light-transmitting second substrate 20 bonded to each other by a sealing material 107 in a predetermined gap. The sealing material 107 is provided along an outer edge of the second substrate 20 to have a frame shape, and a liquid crystal layer 80 is disposed in a region surrounded by the sealing material 107 between the first substrate 10 and the second substrate 20. When the liquid crystal device 100 is used in an electronic apparatus, for example, a first polarizing element is disposed at a side opposite to the first substrate 10 with respect to the second substrate 20, and a second polarizing element is disposed at a side opposite to the second substrate 20 with respect to the first substrate 10. The first polarizing element and the second polarizing element are disposed in crossed Nicols such that their polarization axes are orthogonal to each other.

Both the first substrate 10 and the second substrate 20 have a quadrangle shape, and in a substantially central portion of the liquid crystal device 100, a display region 10a is provided as a rectangular region having a longer dimension in the direction from 3 o'clock toward 9 o'clock, and a shorter dimension in the direction from 0 o'clock toward 6 o'clock. In accordance with the above shapes, the sealing material 107 is also formed in a substantially rectangular shape, and a peripheral region 10b in a quadrangular frame-shape is provided between an inner peripheral edge of the sealing material 107 and an outer peripheral edge of the display region 10a.

The first substrate 10 is made of quartz, glass or the like. In the surface (one surface 10s) of the first substrate 10 at the side of the second substrate 20, in the outside of the display region 10a, a data line driving circuit 101 and a plurality of terminals 102 are formed along one side of the first substrate 10, and a scanning line driving circuit 104 is formed along the other side adjacent to this one side. A flexible wiring substrate 105 is coupled to the terminal 102, and various potentials and various signals are input to the first substrate 10 via the flexible wiring substrate 105.

At the one surface 10s side of the first substrate 10, in the display region 10a, a plurality of light-transmitting pixel electrodes 9a formed of an Indium Tin Oxide (ITO) film or the like, and transistors (not illustrated) electrically coupled to each of the plurality of pixel electrodes 9a are formed in a matrix shape. A first oriented film 16 is formed at the second substrate 20 side with respect to the pixel electrodes 9a, and the pixel electrodes 9a are covered with the first oriented film 16.

The second substrate 20 is made of quartz, glass or the like. A light-transmitting common electrode 21 made of an ITO film is formed at a surface (one surface 20s) of the second substrate 20 at the side of the first substrate 10, and a second oriented film 26 is formed with respect to the common electrode 21 at the side of the first substrate 10. Accordingly, the common electrode 21 is covered by the second oriented film 26. The common electrode 21 is formed substantially entirely at the second substrate 20.

A lens 24 overlapping the pixel electrode 9a is formed between the common electrode 21 and the second substrate 20. The lens 24 directs light to an open region of the first substrate 10. When the lens 24 is formed, a concave curved surface 201 is formed at the one surface 20s of the second substrate 20 at a position overlapping with each of the plurality of pixel electrodes 9a in a one-to-one manner. Further, a lens layer 28 that fills the interior of each of the plurality of concave curved surfaces 201 is provided at the second substrate 20, and the surface 280 of the lens layer 28 at the opposite side to the second substrate 20 is planar. A light-transmitting layer 29 is formed at the surface 280 of the lens layer 28 opposite to the second substrate 20, and a common electrode 21 is formed at a surface 290 opposite to the second substrate 20 of the light-transmitting layer 29.

The refractive index of the lens layer 28 is different from that of the second substrate 20. Thus, the concave curved surface 201 constituted the lens surface 240 of the lens 24. In the exemplary embodiment, the lens layer 28 has a greater refractive index than the second substrate 20. Therefore, the lens 24 has a positive power. In the exemplary embodiment, the second substrate 20 is made of a glass substrate or a quartz substrate (refractive index is 1.48 near a wavelength of 550 nm), and the lens layer 28 is composed of silicon oxynitride (refractive index is from 1.58 to 1.68 near a wavelength of 550 nm). The light-transmitting layer 29 is made of silicon oxide (refractive index is 1.48 near a wavelength of 550 nm).

A light shielding layer 27 having light-shielding properties formed from metal or a metal compound or the like is formed between the lens layer 28 and the light-transmitting layer 29. The light shielding layer 27 is formed, for example, as a partition 27a in a frame-like shape extending along the outer peripheral edge of the display region 10a. Also, the light shielding layer 27 may be formed as a black matrix in a region overlapping in plan view with a region located between pixel electrodes 9a adjacent to each other. In the embodiment, regions overlapping, when viewed in plan view, with the partition 27a in the peripheral region 10b of the first substrate 10 are formed with dummy pixel electrodes 9b formed simultaneously with the pixel electrodes 9a.

The first oriented film 16 and the second oriented film 26 are inorganic oriented film made of SiOₓ(x<2) or the like, and the liquid crystal material with negative dielectric anisotropy used in the liquid crystal layer 80 is substantially vertically oriented. In this way, the liquid crystal device 100 is configured to serve as a VA mode liquid crystal device.

The first substrate 10 includes an inter-substrate conduction electrode 109 being formed in a region positioning outside the sealing material 107 and overlapping with a corner portion of the second substrate 20 such that electrical conduction is established between the first substrate 10 and the second substrate 20. An inter-substrate conduction material 109a including conductive particles is disposed in the inter-substrate conduction electrode 109. The common electrode 21 of the second substrate 20 is electrically coupled to the first substrate 10 side via the inter-substrate conduction material 109a and the inter-substrate conduction electrode 109. Therefore, a common potential is applied to the common electrode 21 from the first substrate 10 side.

The liquid crystal device 100 of the embodiment is configured as a transmissive type liquid crystal device. The liquid crystal device 100 thus configured displays an image in such a manner that light incident from one substrate side of the first substrate 10 and the second substrate 20 is modulated while transmitting the other substrate side to be emitted. In the embodiment, the light incident from the second substrate 20 side, as indicated by an arrow L, is modulated by the liquid crystal layer 80 at each pixel while transmitting the first substrate 10 and emitted, thereby displaying an image. The liquid crystal device 100 may be configured as a reflective type liquid crystal device.

### Configuration of Liquid Crystal Layer 80 and Other Components

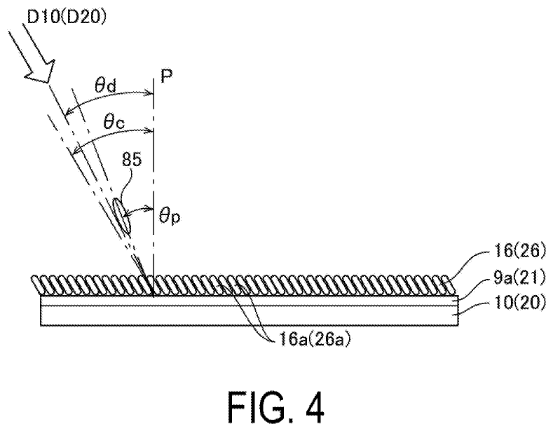

FIG. 3 is an explanatory view of a liquid crystal material 85 or the like used for the liquid crystal layer 80 illustrated in FIG. 2. FIG. 4 is an explanatory view of a method of forming the first oriented film 16 and the second oriented film 26 illustrated in FIG. 3.

In the exemplary embodiment, the first oriented film 16 and the second oriented film 26 illustrated in FIG. 2 are oblique deposition films (inorganic oriented films) made of SiOₓ (x<2), SiO₂, TiO₂, MgO, A1₂O₃, or the like. In the exemplary embodiment, the first oriented film 16 and the second oriented film 26 are oblique deposition films made of SiOₓ. Therefore, as illustrated in FIG. 4, the first oriented film 16 and the second oriented film 26 have a columnar structure in which columnar bodies 16a and 26a, referred to as columns, are respectively formed obliquely with respect to the first substrate 10 and the second substrate 20. Thus, in the first oriented film 16 and the second oriented film 26, the liquid crystal material 85 having negative dielectric anisotropy, which was used in the liquid crystal layer 80, are oriented obliquely with respect to the first substrate 10 and the second substrate 20 to cause the liquid crystal material 85 to be pre-tilted. In a state where no voltage is applied between the pixel electrodes 9a and the common electrode 21, a pre-tilt angle θp denotes an angle formed between a normal direction P with respect to the first substrate 10 and the second substrate 20 and a long axis direction 85a (orientation direction) of the liquid crystal material 85. In the exemplary embodiment, the liquid crystal material 85 is given a positive tilt inclined in the same direction as the inclination of the columnar bodies 16a and 26a.

The orientation Dp of the pre-tilt of the liquid crystal material 85 is the orientation in which the end 852 at the second substrate 20 side is located with respect to the end 851 at the first substrate 10 side of the liquid crystal material 85 in a long axis direction 85a. In the liquid crystal device 100, when a drive voltage is applied between the pixel electrodes 9a and the common electrode 21, the liquid crystal materials 85 incline in the pre-tilt orientation Dp.

The liquid crystal panel 100p is disposed between a pair of polarizing elements disposed in crossed Nichols manner to cause the pre-tilt orientation Dp to form an angle of 45° with respect to a transmission axis or an absorption axis of the pair of polarizing elements. In the exemplary embodiment, for example, as illustrated in FIG. 1, the direction D10 of the deposition direction at the time of forming the first oriented film 16 is, for example, a direction from 7:30 to 1:30 in the clock. At this time, the direction in which the columnar bodies 16a grow is a direction from 1:30 to 7:30 in the clock. The direction D20 of the deposition direction at the time of forming the second oriented film 26 is a direction from 1:30 to 7:30 in the clock. At this time, the direction in which the columnar bodies 26a grow is a direction from 7:30 to 1:30 in the clock. Therefore, the pre-tilt orientation Dp of the liquid crystal material 85 heads from 1:30 to 7:30 in the clock. The pre-tilt orientation Dp intersects with the first direction X and the second direction Y, respectively, at an angle of 45°.

As illustrated in FIG. 4, to form the first oriented film 16, deposition is performed in the direction D10. At that time, the deposition is performed obliquely at an angle θd from the normal P direction with respect to the first substrate 10. As a result, in the first oriented film 16, the columnar bodies 16a are formed in a direction forming an angle θc (column angle) from the normal P direction with respect to the first substrate 10. At that time, the angle θc of the columnar bodies 16a may not be identical to the angle θd of the deposition. However, the angle θc of the columnar bodies 16a is controlled by the angle θd of the deposition.

The liquid crystal materials 85 are pre-tilted by an orientation restriction force of the first oriented film 16. At that time, the pre-tilt angle θp may not be identical to the angle θc of the columnar bodies 16a. However, the pre-tilt angle θp is controlled by the angle θc of the columnar bodies 16a. Therefore, the pre-tilt angle θp is controlled by the angle θd of the deposition. In the embodiment, the first oriented film 16 is formed by setting the angle θd to 45°.

The second oriented film 26 has a configuration identical to the configuration of the first oriented film 16. Therefore, like numbers in parentheses reference like components in FIG. 4, and description of the like components are omitted. However, the planar deposition direction when forming the second oriented film 26 is 180° reverse with respect to the vapor deposition direction when forming the second oriented film 26.

### Range of Pre-tilt Angle θp

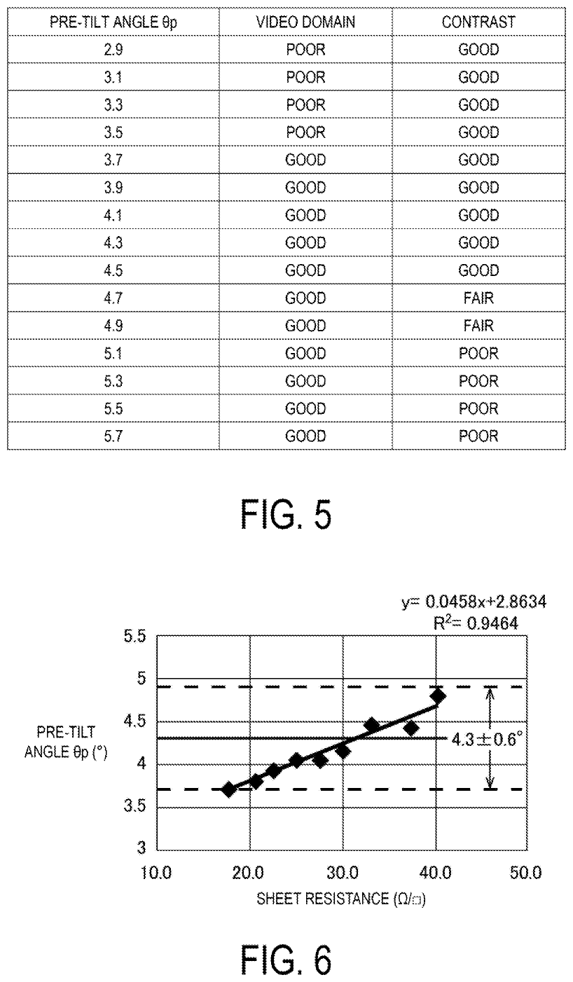

FIG. 5 is an explanatory diagram illustrating an appropriate range of the pre-tilt angle θp illustrated in FIG. 3, and FIG. 5 illustrates evaluation results of the video domain and the contrast as the image quality. For the evaluation results, when excellent, the results are indicated by “good”, and when inferior, indicated by “poor”, and when in-between, indicated by “fair”. In addition, in FIG. 5, as contrast, the ratio is illustrated between the luminance when 5 V is applied to the liquid crystal layer 80 and the luminance when 0 V is applied to the liquid crystal layer 80. In addition, the video domain was evaluated by the extent of the strip-shaped residual image generated when the video was displayed.

In FIG. 3, in the liquid crystal device 100, the smaller the pre-tilt angle θp of the liquid crystal material 85, the greater the contrast ratio between on and off, while the orientation restricting force with respect to the liquid crystal material 85 decreases. As a result, the video domain tends to be generated. Conversely, the larger the pre-tilt angle θp of the liquid crystal material 85, the smaller the contrast ratio is, while the generation of the video domain can be suppressed. Therefore, an appropriate range exists for the pre-tilt angle θp.

According to the results illustrated in FIG. 5, for the video domain, the pre-tilt angle θp may be not less than 3.7°and for the contrast, the pre-tilt angle θp may be not more than 4.9°. Accordingly, in the embodiment, the design target value of the pre-tilt angle θp is set to, for example, 4.3°, and even when the variation occurs, the pre-tilt angle θp is configured to fall within the range of 4.3±0.6° (not less than 3.7° and not more than 4.9°).

In order to achieve such a configuration, it is necessary to appropriately form the first oriented film 16 and the second oriented film 26, and to do that, it is necessary to appropriately manage the surface roughness and the like of the ITO film constituting the pixel electrodes 9a and the common electrode 21. In particular, it is necessary to control the surface roughness or the like of the ITO film constituting the common electrode 21. In the embodiment, it is difficult to manage the surface roughness of the ITO film directly, and therefore, as described below, the sheet resistance of the ITO film or the like and the ratio of the intensity of the crystal plane orientation obtained by X-ray diffraction of the ITO film may be managed, which controls the pre-tilt angle θp.

Such management is performed on the ITO film constituting at least the common electrode 21 of the pixel electrodes 9a and the common electrode 21. However, it may be performed on both the ITO film that constitutes the pixel electrodes 9a and the ITO film that constitutes the common electrode 21.

### Sheet Resistance of ITO Film

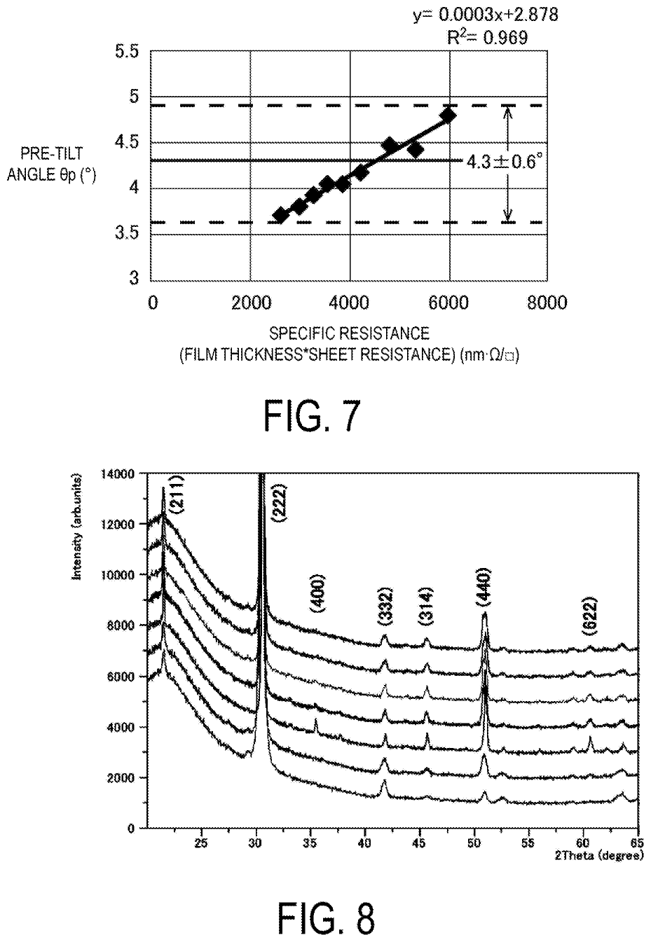

FIG. 6 is a graph illustrating a relationship between the sheet resistance of the ITO film and the pre-tilt angle θp illustrated in FIG. 3. FIG. 7 is a graph illustrating a relationship between the specific resistance of the ITO film and the pre-tilt angle θp illustrated in FIG. 3. Furthermore, FIG. 6 also illustrates a result of approximating the relationship between the sheet resistance of the ITO film and the pre-tilt angle θp to the linear function by the least squares method. FIG. 7 also illustrates a result of approximating the relationship between the specific resistance of the ITO film and the pre-tilt angle θp to the linear function by the least squares method.

As illustrated in FIG. 6, the sheet resistance of the ITO film and the pre-tilt angle θp have a positive correlation, and when the sheet resistance of the ITO film increases, the pre-tilt angle θp increases. In this case, the approximation formula is expressed by the following formula, and the square of the correlation coefficient R is 0.9464.

y=0.0458x+2.8634
x: Sheet resistance (Ω/□)
y: Pre-tilt angle θp (°)

In the embodiment, based on the above approximation formula, the sheet resistance of the ITO film is set to be not less than 19 Ω/□ and not more than 44 Ω/□, so that a pre-tilt angle θp of 4.3±0.6° is achieved. Note that, the lower limit of the sheet resistance of the ITO film is set to 19 Ω/□ by rounding up the decimal part of the value obtained from the approximation formula, and the upper limit of the sheet resistance of the ITO film is set to 44 Ω/□ by rounding down the decimal part of the value obtained from the approximation formula.

As illustrated in FIG. 7, the specific resistance of the ITO film and the pre-tilt angle θp have a positive correlation, and when the specific resistance of the ITO film increases, the pre-tilt angle θp increases. In this case, the approximation formula is expressed by the following formula, and the square of the correlation coefficient R is 0.969.

y=0.0003x+2.878
x: Specific resistance (nm·Ω/□)
y: Pre-tilt angle θp (°)

In the embodiment, the specific resistance of the ITO film is set to be not less than 2740 nm·Ω/□ and not more than 6740 nm·Ω/□, so that the pre-tilt angle θp of 4.3±0.6° is more reliably achieved.

### X-ray Diffraction Results of ITO Film

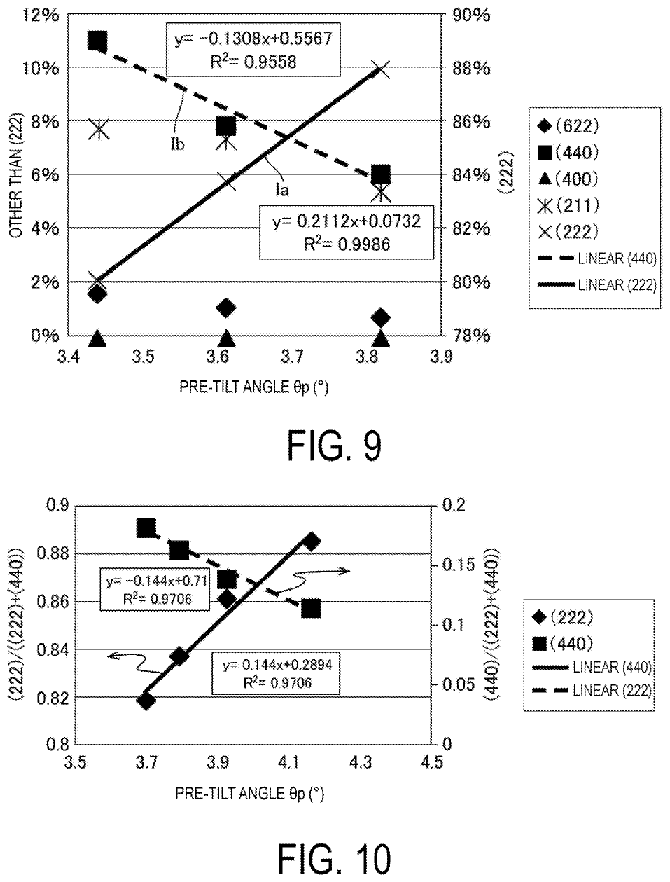

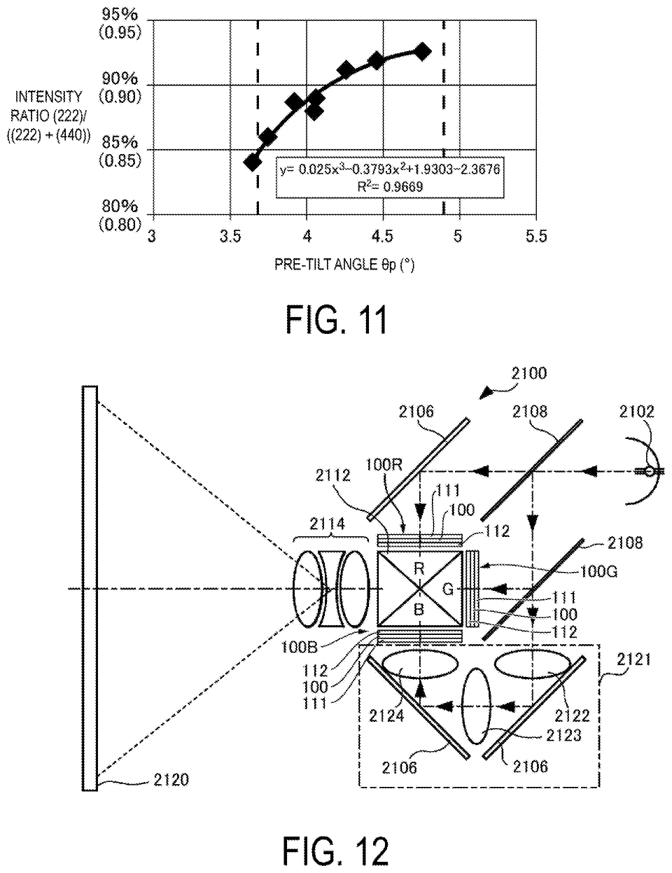

FIG. 8 is an explanatory diagram illustrating the X-ray diffraction results of the ITO film illustrated in FIG. 3. FIG. 9 is an explanatory diagram illustrating a relationship between the intensity of the crystal plane orientations and the pre-tilt angle θp illustrated in FIG. 8, and illustrates a relationship between the intensity of the crystal plane orientations (622), (440), (400), (211), (222) and the pre-tilt angle θp. FIG. 9 also illustrates the results of approximating the intensity Ia of the crystal plane orientation (222) to the linear function, and the results of approximating the intensity Ib of the crystal plane orientation (440) to the linear function. FIG. 10 is an explanatory diagram illustrating a relationship between the ratios of the intensity Ia and Ib illustrated in FIG. 9 and the pre-tilt angle θp, and FIG. 10 illustrates a relationship between the Ia/(Ia+Ib) value, the Ib/(Ia+Ib) value, and the pre-tilt angle θp. FIG. 11 is a graph illustrating the results of approximating Ia/(Ia+Ib) illustrated in FIG. 10 to a cubic function. In addition, “intensity” in the embodiment is the integrated intensity of the corresponding peak.

As illustrated in FIG. 8, film formation conditions such as pressure during film formation are changed and the formed films are subjected to X-ray diffraction, obtaining peaks corresponding to crystal plane orientations (622), (440), (400), (211), (222), or the like. The relative intensities of the crystal plane orientation (622), (440), (400), (211), (222), or the like are changed depending on the film formation conditions.

Furthermore, when film formation conditions such as pressure during film formation are changed and the formed films are used as the second oriented film 26, a relationship between the intensities of crystal plane orientations (622), (440), (400), (211), (222) and the pre-tilt angle θp is as illustrated in FIG. 9. As can be seen in FIG. 9, the intensity Ia of the crystal plane orientation (222) and the intensity Ib of the crystal plane orientation (440) have a high correlation with the pre-tilt angle θp.

For example, when the relationship between the intensity Ia of the crystal plane orientation (222) and the pre-tilt angle θp is approximated to a linear function, the resulting approximation formula is as follows, and the square of the correlation coefficient R is 0.9983.

y=0.2112x+0.0732
x: Pre-tilt angle θp (°)
y: Intensity Ia of the crystal plane orientation (222)

When the relationship between the intensity Ib of the crystal plane orientation (440) and the pre-tilt angle θp is approximated to a linear function, the resulting approximation formula is as follows, and the square of the correlation coefficient R is 0.9558.

y=−0.1308x+0.5567
x: Pre-tilt angle θp (°)
y: Intensity Ib of the crystal plane orientation (440)

Additionally, the relationship between the value of Ia/(Ia+Ib), the value of Ib/Ia+Ib), and the pre-tilt angle θp are as illustrated in FIG. 10, and the values of the Ia/(Ia+Ib) and Ib/(Ia+Ib) have a high correlation with the pre-tilt angle θp.

For example, when the relationship between the Ia/(Ia+Ib) value and the pre-tilt angle θp is approximated to a linear function, the resulting approximation formula is as follows, and the square of the correlation coefficient R is 0.9706.

y=0.144x+0.2894
x: Pre-tilt angle θp (°)
y: Ia/(Ia+Ib)

In addition, when the relationship between the Ib/(Ia+Ib) value and the pre-tilt angle θp is approximated to a linear function, the resulting approximation formula is as follows, and the square of the correlation coefficient R is 0.9706.

y=−0.144x+0.71
x: Pre-tilt angle θp (°)
y: Ib/(Ia+Ib)

In the embodiment, the relationship between the value of Ia/(Ia+Ib) and the pre-tilt angle θp is approximated to a cubic function, and the range of Ia/(Ia+Ib) is set based on this approximation formula. More specifically, as illustrated in FIG. 11, when the relationship between the Ia/(Ia+Ib) value and the pre-tilt angle θp is approximated to a cubic function, the resulting approximation formula is as follows, and the square of the correlation coefficient R is0.9669.

y=0.025x³+0.3793x²+1.9303x−2.3676
x: Pre-tilt angle θp (°)
y: Ia/(Ia+Ib)

According to the result illustrated in FIG. 11, when the intensity Ia of the crystal plane orientation (222) and the intensity Ib of the crystal plane orientation (440) satisfy the following relationship, a pre-tilt angle θp of 4.3±0.6° can be more reliably achieved.

0.85≤(Ia/(Ia+Ib))≤0.92

Note that, the lower limit of Ia/(Ia+Ib) is set to 0.85 by rounding up the third decimal place of the value obtained from the approximation formula, and the upper limit of Ia/(Ia+Ib) is set to 0.92 by rounding down the third decimal place of the value obtained from the approximation formula.

### Main Effects of Embodiment

As described above, in the embodiment, the pre-tilt angle θp of 4.3±0.6° is achieved by managing the sheet resistance of the ITO film used in the second oriented film 26, or the like, and the ratio of the intensity of the crystal plane orientation obtained by X-ray diffraction of the ITO film. Thus, even when the surface roughness of the ITO film is not measured, it is possible to achieve a liquid crystal device 100 that is superior in terms of the video domain and the contrast.

More specifically, since the common electrode 21 includes ITO film having a sheet resistance of not less than 19Ω/□ and not more than 44 Ω/□, the pre-tilt angle θp can be 4.3±0.6°.

In addition, since the specific resistance, which is the product of the sheet resistance and the film thickness of the ITO film used in the common electrode 21 is set to not less than 2740 nm·Ω/□ and not more than 6740 nm·Ω/□, ITO film can be appropriately managed even when the film thickness of the ITO film is changed, so that the pre-tilt angle θp can be set to 4.3±0.6°.

Furthermore, in the X-ray diffraction results of the ITO film used in the common electrode 21, since the intensity Ia of the crystal plane orientation (222) and the intensity Ib of the crystal plane orientation (440) satisfy the relationship below, the pre-tilt angle θp can be more appropriately controlled, so that the pre-tilt angle θp can be set to 4.3±0.6°.

0.85≤(Ia/(Ia+Ib))≤0.92

### Other Exemplary Embodiments

Although the above exemplary embodiments have been described when the liquid crystal device 100 is in the normally black mode, the present disclosure may be applied when the liquid crystal device 100 is in the normally white mode.

In the exemplary embodiment described above, the ITO film that constitutes the pixel electrode 9a is described with reference to the management of the ITO constituting the common electrode 21, The management described in the above exemplary embodiments may be performed on both of the ITO constituting the pixel electrode 9a and the ITO constituting the common electrode 21.

### Installation Example to the Electronic Apparatus

A projection-type display device (liquid crystal projector) will be described as an example of the electronic apparatus using the liquid crystal device 100 according to the above-described exemplary embodiments. FIG. 12 is an explanatory view of a projection-type display device using a transmissive type liquid crystal device. A projection-type display device 2100 illustrated in FIG. 12 is provided with a liquid crystal device 100 to which the present disclosure is applied, a light source unit configured to emit light supplied to the liquid crystal device 100, and a projection optical system configured to project light modulated by the liquid crystal device 100.

The projection-type display device 2100 is provided with a lamp unit 2102 (light source unit) including a white light source, such as a halogen lamp. Projection light emitted from the lamp unit 2102 is split into three primary colors of red (R), green (G), and blue (B) by three mirrors 2106 and two dichroic mirrors 2108 installed inside. The split projection light is guided to light valves 100R, 100G, and 100B corresponding to each of the primary colors, respectively and is modulated. Note that, since the light of the B color has a long optical path as compared to the other light of the R color and the G color, the light of the B color is guided via a relay lens system 2121 including an incidence lens 2122, a relay lens 2123, and an emission lens 2124 to prevent a loss due to the long optical path of the light of the B color. The light valves 100R, 100G, and 100B each include an incident-side polarization separation element 111 overlapping, on an incident side, with the liquid crystal device 100, and an emission side polarization separation element 112 overlapping, on an emission side, with the liquid crystal device 100.

The light modulated by each of the light valves 100R, 100G, and 100B is incident on a dichroic prism 2112 from three directions. Then, at the dichroic prism 2112, the light of the R color and the light of the B color are reflected at 90 degrees, and the light of the G color is transmitted. Accordingly, an image of the primary colors are synthesized, and subsequently a color image is projected on a screen 2120 by a projection lens group 2114 (projection optical system).

### Other Projection-Type Display Device

A projection-type display device may be configured to use, as a light source unit, an LED light source configured to emit light in various colors, or the like to supply light in various colors emitted from the LED light source to different light valves respectively.

### Other Electronic Apparatuses

The electronic apparatus including the liquid crystal device 100 to which the present disclosure is applied is not limited to the projection-type display device 2100 of the above-described exemplary embodiment. Examples of the electronic apparatus may include a projection-type Head Up Display (HUD), a direct-view type Head-Mounted Display (HMD), a personal computer, a digital still camera, and a liquid crystal television.

What is claimed is:

1. A liquid crystal device, comprising:
a pixel electrode;
a common electrode;
a first oriented film covering the pixel electrode;
a second oriented film covering the common electrode; and
a liquid crystal layer that is disposed between the first oriented film and the second oriented film and that includes a liquid crystal material, wherein
at least the common electrode, of the pixel electrode and the common electrode, includes an ITO film with a sheet resistance not less than 19 Ω/□ and not more than 44 Ω/□ and
a pre-tilt angle that is a tilt angle of the liquid crystal material with respect to a thickness direction of the liquid crystal layer is not less than 3.7° and not more than 4.9°.

2. The liquid crystal device according to claim 1, wherein the ITO film has a specific resistance of not less than 2740 nm·Ω/□ and not more than 6740 nm·Ω/□, the specific resistance being a product of a sheet resistance and a film thickness.

3. The liquid crystal device according to claim 1, wherein according to an X-ray diffraction result of the ITO film, 0.85≤(Ia/(Ia+Ib))≤0.92, where Ia is an intensity of a crystal plane orientation (222) and Ib is an intensity of a crystal plane orientation (440).

4. The liquid crystal device according to claim 1, wherein both of the pixel electrode and the common electrode include the ITO film.

5. The liquid crystal device according to claim 1, wherein the first oriented film and the second oriented film each include a columnar structure including a columnar body tilted obliquely with respect to a thickness direction of the liquid crystal layer.

6. An electronic apparatus, comprising the liquid crystal device according to claim 1.
